(19) United States
(12) Patent Application Publication
(10) Pub. No.: US 2023/0308939 A1
(43) Pub. Date: Sep. 28, 2023

(54) TECHNIQUE FOR CONTROLLING PERFORMANCE MANAGEMENT DEPENDING ON NETWORK LOAD

(71) Applicant: Telefonaktiebolaget LM Ericsson (publ), Stockholm (SE)

(72) Inventors: Michal Socha, Kraków (PL); Dominik Budyn, Dobczyce (PL); Szymon Galuszka, Kraków (PL); Domagoj Premec, Zagreb (HR)

(21) Appl. No.: 18/022,227

(22) PCT Filed: Aug. 20, 2020
(86) PCT No.: PCT/EP2020/073320

§ 371 Date: Feb. 20, 2023

(51) Int. Cl. H04W 28/02; H04W 28/06

(52) U.S. Cl. CPC H04W 28/0278; H04W 28/0205; H04W 28/06

(57) ABSTRACT

A method for controlling a performance management (PM) depending on a load at a network node in a wireless communications system comprises or initiates assigning a priority to at least one PM event of the PM. The assigned priority is selected from a set of priorities comprising a normal priority and one or more further priorities greater than the normal priority. The method further comprises or initiates monitoring a filling status of a PM buffer comprising instances of the at least one PM event. The monitoring of the filling status comprises monitoring if the filling status is greater than a threshold value. The method further comprises or initiates selectively discarding instances of the at least one PM event from the PM buffer depending on the assigned priority, if the filling status of the PM buffer is greater than the threshold value.

### TECHNICAL FIELD

The present disclosure relates to a technique for controlling performance management (PM). More specifically, and without limitation, a method and a device are provided for controlling a PM depending on a load at a network node in a wireless communications system.

### BACKGROUND

The Radio Access Control (RAC) layer in a network node (e.g. an evolved NodeB or briefly eNB according to the 4G Long Term Evolution, LTE, standard of the Third Generation Partnership Project, 3GPP) implements multiple mechanisms for overload protection in order to prevent a system crash of the network node at spikes of data traffic. The essence of the conventional overload protection mechanisms is that the network node should reject new incoming connections (e.g., attaches and handovers). The 3GPP document TS 32.425, version 16.5.0, discusses the need for performance management (PM) related to unnecessary handovers as well as the use of a large number of counters.

However, the overload protection does not prevent a network node (e.g., an eNB) from a system crash. System crashes were found to be often caused by how the PM works in the network node. PM data (e.g., counters, PM events or exception events) are handled by a different PM thread that runs on a priority lower than traffic handling. For event counter such as peg counters, an inter-thread communication between the PM threads is needed, and the PM thread needs to get time to execute under its lower priority. On a network node that is handling extreme overload, the execution may not always be possible, and the network node may crash, e.g., due to an overflow of a signaling pool.

A conventional network node can reject radio devices (also denoted as user equipments, UEs) under high load to prevent a system crash. However, rejecting radio devices can lead to increased PM traffic (e.g., PM events), which is currently unprotected and can cause the system crash of the network node in the first place.

Various workarounds were proposed and tested, all of them based on the idea of reducing the observability of the PM events by a manual intervention of the operator on the affected network node (e.g., the eNB). Thus, this approach is not accepted by providers of wireless communication systems. Rather, wireless communication system providers require the network node to be robust under high load conditions. It is not considered acceptable that PM traffic will cause a system crash of the network node.

### SUMMARY

Accordingly, there is a need for a technique for controlling performance management (PM) depending on load conditions at a network node that improves a robustness of the network node or prevents at least one of a system crash and a restart of the network node under conditions of high load or overload.

As to a method aspect, a method of controlling a PM depending on a load at a network node in a wireless communications system is provided. The method comprises or initiates a step of assigning a priority to at least one PM event of the PM. The assigned priority is selected from a set of priorities comprising a normal priority and one or more further priorities greater than the normal priority. The method further comprises or initiates a step of monitoring a filling status of a PM buffer comprising instances of the at least one PM event. The monitoring of the filling status comprises monitoring if the filling status of the PM buffer filled with the instances of the at least one PM event is greater than a threshold value. The method further comprises or initiates a step of selectively discarding instances of the at least one PM event from the PM buffer depending on the assigned priority, if the filling status of the PM buffer is greater than the threshold value.

By assigning the priorities to the at least one PM event and monitoring the filling status of the buffer, embodiments of the technique for controlling of the PM depending on load conditions at a network node can improve the robustness of the network node and/or prevent a system crash or a restart of the network node under high load or overload conditions by selectively discarding instances of the at least one PM event from the PM buffer depending on the assigned priority, in response to the filling status of the PM buffer being greater than the threshold value.

Alternatively or in addition, by virtue of embodiments of the technique, the network node can operate robustly even if PM is executed at a priority (e.g., a process priority) that is lower than traffic handling at the network nodes, e.g., executed at a priority lower than the priority of a radio protocol stack at the network node.

Alternatively or in addition, embodying the technique can increase the number of radio devices served by a network node. Same or further embodiments can reduce an observability of PM events without increasing signaling, e.g., from the network node towards a core network (CN) of the wireless communication system. For example, embodiments of the technique can avoid an overflow of a signaling pool between load modules during the condition of high load or overload.

The technique may be implemented by methods and devices for improving a robustness of a network node, e.g. under the condition of high load and/or overload, for reducing the risk of a system crash or a restart of the network node, and/or for enabling a network node to serve a larger number of radio devices. Alternatively or in addition, a technique is provided that allows changing the observability of PM events and/or the amount of PM traffic in dependence of the load at the network node.

The load may be indicative of an average data rate at the network node (e.g., the sum of all radio devices connected to the network node) or a number of radio devices (e.g., UEs) in a connected state with the network node. Alternatively or in addition, the PM buffer (also: “event buffer”) and/or the instances of the at least one PM event and/or the filling status of the PM buffer may be indicative of the load of the network node.

The network node may comprise a baseband unit (e.g., as a radio node) and/or a distributed unit (DU) (e.g., as a radio node).

The filling status of the PM buffer may comprise or assume a filling status “empty” or a filling status “full”. Optionally, the filling status of the PM buffer (e.g., the PM buffer of an event agent “EventAgentLM”) may comprise or assume an intermediary filling status that is intermediary between “empty” and “full”.

Alternatively or in addition, the PM buffer may comprise a plurality of event buffers. The filling status of the PM buffer may correspond to a number (e.g., a fraction) of the event buffers, the status of which is “full”. For example, only a total number or percentage of full event buffers within one instance of an event agent (e.g., EventAgentLM) may be counted.

The normal priority may be the smallest priority in the set of priorities. The normal priority may also be denoted as low priority. The at least one further priority greater than the normal priority may comprise a key performance indicator (KPI) and/or may be associated to a KPI.

The set of priorities may comprise at least two different priorities. E.g., if the set comprises exactly two priorities, the priorities may be denoted as normal and high (or “higher”), respectively.

The set of priorities may comprise at least three different priorities, including the lowest priority denoted as normal priority and at least two further (e.g. “higher”) priorities greater than the normal priority.

Herein, “stepping” or “stepped” (e.g., in the context of one or more counters) may encompass “incrementing” or “incremented”.

A PM event may also be denoted as, or may be represented by, PM traffic. A PM event may comprise, or may be associated with, a PM counter. For example, the stepping of a PM counter may depend on a target observation level. If the target observation level refers to counters and events (e.g., is “COUNTER AND EVENT”), all counters will be stepped. If the target observation level relates to KPI (e.g., is “KPI”), only KPI-related counters will be stepped.

A PM event may comprise at least one of an Evolved Packet System (EPS) event and a 5G System (5GS) event. Alternatively or in addition, the PM counter may comprise at least one of an EPS counter and a 5GS counter. Alternatively or in addition, a PM event may relate to a mission critical service (MCS).

The monitoring of the filling status of the PM buffer may be performed for a plurality of event buffers, e.g., comprised in a load module (LM). Each of the event buffers (e.g., 64 event buffers with 62 kilobytes (kB) each) may pertain to one of multiple copies of an event agent of a load module (e.g., EventAgentLM) within a cell load module (e.g., CelILM) and/or within a central load module (e.g., CentralLM).

Any threshold value may be a predefined threshold value (e.g., a threshold configured by an operations support system, OSS, and/or a network manager, NM).

Alternatively or in addition, the threshold value may be a first threshold value (e.g., among a plurality of threshold values), e.g., a first predefined threshold value.

The threshold value may also be denoted as first threshold value and/or as a threshold for a mode activation of the selectively discarding (i.e., selectively discarding mode activation threshold or briefly: activation threshold). The selective discarding may be activated or enabled if the filling status of the PM buffer exceeds the (e.g. first) threshold value. For example, the (e.g. first) threshold value may initially be set to 50%. E.g., for an EventAgentLM comprising N event buffers (e.g., 64 event buffers or briefly: buffers), the filling status may be greater than (i.e., above) the initially set (e.g. first) threshold value if more than N/2 event buffers (e.g., 32 event buffers) are “full” (also: “used”) and/or are storing data related to instances of the at least one PM event.

The selectively discarding may be enabled (i.e., activated) when the filling status is greater than the (e.g. first) threshold value. The selectively discarding may be disabled (i.e., deactivated) when the filling status is less than a second threshold value, which is less than the (e.g. first) threshold value.

A second threshold value less than the (e.g. first) threshold value may initially be set, e.g., to 30%. If (e.g., after a time during which the filling status of the PM buffer is greater than, e.g., above, the first threshold value and/or the selective discarding is activated or enabled) a filling status of the PM buffer less than the second threshold value is monitored (i.e., detected), the selectively discarding may be deactivated and/or abandoned. The second threshold value may also be denoted as a threshold for mode deactivation of the selectively discarding (i.e., selectively discarding mode deactivation threshold or briefly: deactivation threshold).

Alternatively or in addition, the (e.g. first) threshold value may be set according to a parameter of the PM, e.g., a parameter of a Managed Object Model (MOM) of the PM. For example, the first threshold value may indicate high load (also denoted as overload status or shortly: overload). Optionally, a third threshold value greater than the first threshold value may indicate a very high load and/or increased level of overload. If the filling status is greater than the third threshold value, the network node may start rejecting new incoming connections of radio devices (e.g., attaches and handovers of the radio devices), or may reject more radio devices, to reduce a processing load (e.g., an overall CPU load) at the network node.

Selectively discarding an instance of the PM event may comprise omitting to forward the instance or instances of the PM event, e.g. omitting to forward from an instance of an EventAgentLM within a CelILM and/or within a CentralLM to an EventAgentRouter within a MonitorLM. The CelILM and/or the CentralLM may be assigned greater priority (e.g. a greater internal priority of a thread in the software of the network node) than the MonitorLM. For example, priorities for all threads may be statically defined without plans to change them. In an exemplary network node, each of CelILM and CentralLM have a priority greater than (i.e., higher than) MonitorLM, which can be one of the root causes for problems with the robustness of the network node (e.g., eNB). The priority of MonitorLM may not be changed as it would reduce a capacity of the network node (e.g., eNB). Alternatively or in addition, selectively discarding the instance of the PM event may comprise deleting the instance of the PM event from the PM buffer.

Forwarding the instance or instances of the at least one PM event may be denoted as observability of the respective PM event.

Forwarding the instance or instances of the PM event may comprise further forwarding the instance of the PM event from the MonitorLM within the network node to an (e.g. external) OSS. The OSS may be (e.g., may be embodied by) a Network Manager (NM).

The method may be performed by the network node, e.g. as a technique for deciding whether to forward an instance of a PM event from one entity to another within the network node.

Embodiments of the technique can improve a robustness of a network node under high load and/or overload conditions by reducing the risk of a network node restart caused by PM events overload (and/or, e.g., subsequent network node crash, optionally followed by a restart). Same or further embodiments can allow for an automatic detection of conditions of high load or overload and for a (e.g., successive) reduction of observability in a controlled way. Any of the embodiments may allow an operator (e.g., without the need for manual intervention) to keep PM counters and/or KPI related data from contributing or causing conditions of high load and/or overload, and/or to reduce the risk of a system crash at the network node.

The selectivity in the step of selectively discarding may comprise discarding instances of the at least one PM event with a priority less than a predefined priority. For example, instances of the at least one PM event with normal priority and/or low priority may be discarded.

The predefined priority may be a configured priority, e.g., configured by an OSS and/or a CN of the wireless communications system.

Herein, one priority may be “less” or “greater” than another priority, if the one priority is lower or higher, respectively, than the other priority according to an order or rank or hierarchy of the priorities.

Alternatively or in addition, the selectivity of the discarding may comprise discarding instances of the at least one PM event for one or more radio devices (e.g. UEs). E.g., the priority of the PM event may depend on the radio device for which the data associated with the instance of the at least one PM event is destined. The selectivity of the selectively discarding in dependence of the radio device may, for example, be activated (i.e., may be started and/or may be on and/or may be operative) if the filling status of the PM buffer is greater than (e.g., above) the third threshold value.

The selectivity of the selectively discarding in dependence of the radio device may in particular comprise the network node rejecting (e.g. requests related to) attaches and/or handovers of or from incoming radio devices.

The step of monitoring the filling status of the PM buffer may further comprise monitoring if the filling status of the PM buffer is greater than a third threshold value. The third threshold value may be greater than the (e.g., first) threshold value.

The step of selectively discarding may further comprise, if the filling status of the PM buffer is greater than the third threshold value, starting to discard instances of the at least one PM event from the PM buffer:
for a group of radio devices (e.g., among the radio devices served by the network node and/or accessing the network node); and/or
irrespective of the assigned priority; and/or
for all PM events except of at least one essential PM event.

The at least one essential PM event may comprise INT_SUPERVISOR type and/or PM events that have a major contribution to the functionality of the network node (e.g., the eNB).

Alternatively or in addition (e.g., instead of dropping all events irrespective of the assigned priority), the network node may and/or the step of selectively discarding may further comprise, if the filling status of the PM buffer is greater than the third threshold value (i.e., due to PM overload), starting to reject at least one radio device (e.g., all radio devices not currently served by the network node), e.g., upon attach or handover.

Moreover, the step of monitoring a filling status of a PM buffer may further comprise monitoring if the filling status of the PM buffer is less than a fourth threshold value. The fourth threshold value may be greater than the (e.g., first) threshold value and the fourth threshold value may be less than the third threshold value.

The network node may and/or the step of selectively discarding may further comprise, if the filling status of the PM buffer is less than the fourth threshold value, stopping to discard instances of the at least one PM event irrespective of the assigned priority.

Alternatively or in addition, the network node may and/or the step of selectively discarding may further comprise, if the filling status of the PM buffer is less than the fourth threshold value, stopping to reject the at least one radio device (e.g., all radio devices not currently served by the network node).

By selectively discarding instances of PM events using a static (and/or automatic) priority assignment and load status monitoring method, a signaling pool overflow may be avoided and a robustness of the network node may be improved.

Alternatively or in addition, by automatically controlling the PM traffic, in particular at high load, a larger number of UEs may be served than in conventional scenarios requiring manual monitoring of the load status and/or requiring manual discarding of PM events.

A mode of selectively discarding instances of PM events may also be denoted as reduced observability mode.

The method may be implemented in the network node, e.g. in the radio admission control (RAC) of the network node. The network node may comprise a Node B (NB) according to a 3G standard (e.g., according to 3GPP), an evolved NB (eNB) according to a 4G standard (e.g., according to 3GPP LTE) or a gNB according to a 5G standard (e.g., 3GPP New Radio, NR).

The network node may be wirelessly connected or connectable to a plurality of radio devices. The load at the network node may be represented by the buffer status and/or the instances of the at least one PM event. Alternatively or in addition, the load at the network node may depend on the connected radio devices, e.g., the number and/or the activity of the connected radio devices.

The selectively discarding may comprise discarding instances of the at least one PM event from the PM buffer, to which the normal priority is assigned, optionally if the at least one further priority comprises exactly one further priority that is greater than the normal priority.

Alternatively or in addition, the selectively discarding may comprise discarding instances of the at least one PM event from the PM buffer, to which a priority less than a preselected one of the further priorities greater than the normal priority is assigned, optionally if the one or more further priorities comprises at least two further priorities that are greater than the normal priority.

The method may further comprise a step of reporting a selectively discarding mode responsive to monitoring that the filling status of the PM buffer filled with instances of the at least one PM event is greater than the (e.g. first) threshold value. The selectively discarding mode may comprise selectively discarding instances of the at least one PM event from the PM buffer depending on the assigned priority.

The step of monitoring the filling status of the PM buffer may further comprise monitoring if the filling status of the PM buffer is less than a second threshold value. The second threshold value may be less than the (e.g. first) threshold value.

The step of selectively discarding instances of PM events may comprise not discarding any instance of the at least one PM event from the PM buffer (e.g., stopping the selective discarding), if the filling status of the PM buffer is less than the second threshold value.

Not discarding any instance of PM events may comprise forwarding and/or reporting all instances of PM events. Alternatively or in addition, not discarding any instance of PM events from the PM buffer may comprise changing priorities of PM events, e.g. assigning the same priority (e.g. high priority or the highest priority within the set of priorities) to all PM events.

The step of monitoring the filling status of the PM buffer may further comprise monitoring if the filling status of the PM buffer is greater than a third threshold value. The third threshold value may be greater than the (e.g. first) threshold value.

The step of selectively discarding instances of PM events may comprise discarding instances of PM events for one or more radio devices within a plurality of radio devices to which the network node is connected and/or rejecting at least one unconnected radio device, if the filling status of the PM buffer is greater than a third threshold value.

Any PM event destined for one or more radio devices may be produced within network node software (SW) components of the network node, e.g., based on data received over a Uu interface and/or at the network node (e.g., eNB), and/or over an X2 interface from another network node (e.g., another eNB), and/or over an Si interface from the CN.

Controlling the PM traffic may comprise or use two (e.g., successive) threshold values for the increasing load. The two successive threshold values may be denoted as first and third threshold value. The filling status of the PM buffer greater than (i.e., above) the first threshold value and less than (i.e., below) the third threshold value may be denoted as “high load”. The filling status of the PM buffer greater than (i.e., above) the third threshold value may be denoted as “overload”.

The step of monitoring a filling status of a PM buffer may further comprise monitoring if the filling status of the PM buffer is less than a fourth threshold value. The fourth threshold value may greater than the (e.g. first) threshold value. The fourth threshold value may be less than the third threshold value.

The step of selectively discarding instances of PM events may comprise discarding instances of the at least one PM event from the PM buffer depending on the assigned priority, optionally limited to instances of the at least one PM event for radio devices in a disconnected or idle state and/or for incoming connections. Alternatively or in addition, the selectively discarding of instances of PM events may exclude from discarding (i.e., may not discard) instances of PM events for one or more radio devices within a plurality of radio devices to which the network node is connected.

The (e.g. first) threshold value may be a configurable parameter for the filling status of the PM buffer. Alternatively or in addition, the second threshold value may be a configurable parameter for the filling status of the PM buffer. Further alternatively or in addition, the third threshold value may be a configurable parameter for the filling status of the PM buffer. Still further alternatively or in addition, the fourth threshold value may be a configurable parameter for the filling status of the PM buffer. For example, any one of the first, second, third and fourth threshold value may be a parameter of a MOM of the PM.

The at least one configurable parameter for the filling status of the PM buffer may be specific and/or unique to the network node.

Each of the threshold values for the filling status of the PM buffer may be the same for all hierarchically (e.g. in terms of the forwarding of the instance of the PM event) equivalent PM buffers. E.g., the configurable parameter for the filling status of the PM buffer may be the same for each instance of the EventAgentLM within the CelILM and/or within the CentralLM of the network node.

The at least one further priority may comprise four priorities. Alternatively or in addition, the set of priorities may comprise five priorities. The five priorities may be denoted (e.g. in increasing order) as NORMAL, COUNTER_AND_EVENT, COUNTER, KPI and INTERNAL_SUPERVISOR.

The method may be performed by a radio access control (RAC) layer of the network node. Optionally, the method may be performed by each instance of a plurality of instances of an event agent (e.g. EventAgentLM) of a cell load module (e.g. CelILM) and/or of a central load module (e.g. CentralLM) within the RAC layer.

The method aspect may be performed at or by a network node for a downlink connection to a radio device and/or a backhaul connection to another network node.

The channel or link used for the data transmission and the radio reception, i.e., the channel between the network node and the radio device (and/or the other network node) may comprise multiple subchannels or subcarriers (as a frequency domain). Alternatively, or in addition, the channel or link may comprise one or more slots for a plurality of modulation symbols (as a time domain). Alternatively, or in addition, the channel or link may comprise a directional transmission (also: beamforming transmission) at the network node, a directional reception (also: beamforming reception) at the radio device (and/or at the other network node) or a multiple-input multiple-output (MIMO) channel with two or more spatial streams (as a spatial domain).

The network node and the radio device and/or the other network node may be spaced apart. The network node and the radio device (and/or the other network node) may be in data or signal communication exclusively by means of the radio communication.

In any aspect, the network node and the radio device (and/or the other network node) may form, or may be part of, a radio network, e.g., according to the Third Generation Partnership Project (3GPP) or according to the standard family IEEE 802.11 (Wi-Fi). The radio network may be a radio access network (RAN) comprising one or more network nodes (also: “base stations”). Alternatively, or in addition, the radio network may be a vehicular, ad hoc and/or mesh network. The method aspect may be performed by one or more embodiments of the network node in the radio network.

Any of the radio devices may be a mobile or wireless device, e.g., a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and/or consumer electronics.

Any of the radio devices may be wirelessly connected or connectable (e.g., according to a radio resource control, RRC, state or active mode) with any of the network nodes (also denoted as base stations). Herein, the base station may encompass any station that is configured to provide radio access to any of the radio devices. The base station may also be referred to as transmission and reception point (TRP), radio access node or access point (AP). The base station or one of the radio devices functioning as a gateway (e.g., between the radio network and the RAN and/or the Internet) may provide a data link to a host computer providing the data. Examples for the base station may include a 3G base station or Node B (briefly: NB), 4G base station or eNodeB (briefly: eNB), a 5G base station or gNodeB (briefly: gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer and/or a Radio Resource Control (RRC) layer of a protocol stack for the radio communication.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a device aspect, a device for controlling a PM depending on a load at a network node in a wireless communications system is provided. The device may be configured to perform any one of the steps of the method aspect. Alternatively, or in addition, the device may comprise a PM event priority assigning unit configured to assign a priority to at least one PM event of the PM, wherein the assigned priority is selected from a set of priorities comprising a normal priority and one or more further priorities greater than the normal priority. The device may further comprise a PM buffer status monitoring unit configured to monitor a filling status of a PM buffer comprising instances of the at least one PM event, wherein the monitoring of the filling status comprises monitoring if the filling status of the PM buffer filled with instances of PM events is greater than a (e.g. first) threshold value. The device may further comprise a selectively discarding PM events unit configured to selectively discard instances of the at least one PM event from the PM buffer depending on the assigned priority, if the filling status of the PM buffer is greater than the (e.g. first) threshold value.

As to a further device aspect, a device for controlling a PM depending on a load at a network node in a wireless communications system is provided. The device comprises processing circuitry, e.g., at least one processor and a memory. Said memory may comprise instructions executable by said at least one processor. The device is operative to assign a priority to at least one PM event of the PM, wherein the assigned priority is selected from a set of priorities comprising a normal priority and one or more further priorities greater than the normal priority. The device is further operative to monitor a filling status of a PM buffer comprising instances of the at least one PM event, wherein the monitoring of the filling status comprises monitoring if the filling status of the PM buffer filled with instances of PM events is greater than a (e.g. first) threshold value. The device is further operative to selectively discard instances of the at least one PM event from the PM buffer depending on the assigned priority, if the filling status of the PM buffer is greater than the (e.g. first) threshold value.

The device may be further operative to perform any one of the steps of the method aspect.

As to a still further device aspect, a base station (e.g., a network node) configured to communicate with a user equipment (UE) is provided. The base station comprises a radio interface and processing circuitry configured to execute any one of the steps of the method aspect.

As to a still further aspect, a communication system including a host computer is provided. The host computer comprises a processing circuitry configured to provide user data, e.g., depending on the location of a UE. The host computer further comprises a communication interface configured to forward user data to a cellular or ad hoc network for transmission to the UE. The cellular network further comprises a base station configured to communicate with the UE. The base station comprises a radio interface for communicating with the UE and processing circuitry, the processing circuitry of the base station being configured to execute any one of the steps of the method aspect.

The communication system may further include the UE. The UE may comprise a radio interface for communicating with the base station.

The processing circuitry of the host computer may be configured to execute a host application, thereby providing the user data and/or any host computer functionality described herein. Alternatively, or in addition, the processing circuitry of the UE may be configured to execute a client application associated with the host application.

Any one of the devices, the UE, the base station, the system or any network node or base station for embodying the technique may further include any feature disclosed in the context of the method aspect, and vice versa. Particularly, any one of the units and modules, or a dedicated unit or module, may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows an example schematic block diagram of a device for controlling a performance management (PM) depending on a load at a network node;

FIG. 2 shows an example flowchart for a method of controlling a PM depending on a load at a network node, which method may be implementable by the device of FIG. 1;

FIG. 3 shows a schematic block diagram of an embodiment of the device of FIG. 1;

FIG. 4 schematically illustrates a first example flowchart for monitoring a load at a network node and selectively discarding PM events depending on the load status, which may be usable for the method of FIG. 2;

FIG. 5 schematically illustrates a second example flowchart for monitoring a load at a network node and selectively discarding PM events depending on the load status, which may be usable for the method of FIG. 2;

FIG. 6 shows an example schematic block diagram of a network node embodying the device of FIG. 1;

FIG. 7 schematically illustrates an example telecommunication network connected via an intermediate network to a host computer;

FIG. 8 shows a generalized block diagram of a host computer communicating via a base station or radio device functioning as a gateway with a user equipment over a partially wireless connection; and

FIGS. 9 and 10 show flowcharts for methods implemented in a communication system including a host computer, a base station (or radio device functioning as a gateway) and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a 3GPP LTE or 4G (comprising, e.g., LTE-Advanced or a related radio access technique such as MulteFire) implementation, it is readily apparent that the technique described herein may also be implemented for any other radio communication technique, including 3GPP New Radio (NR) or 5G, in a Wireless Local Area Network (WLAN) according to the standard family IEEE 802.11, for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

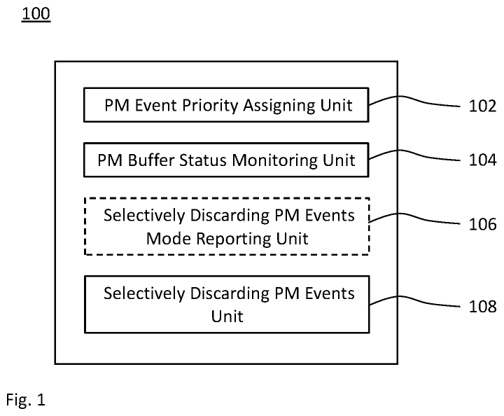

FIG. 1 schematically illustrates an example block diagram of a device for controlling a PM depending on a load at a network node. The device is generically referred to by reference sign 100.

The device 100 comprises a PM event priority assigning unit 102 that is configured to assign a priority to one or more PM events of the PM. The assigned priority may be selected from a set of priorities comprising a normal (also denoted as “low”) priority and at least one further priority greater (or “higher”) than the normal priority. The device 100 further comprises a PM buffer status monitoring unit 104 that is configured to monitor a filling status of a PM buffer comprising instances of the one or more PM events. The monitoring of the filling status may comprise monitoring if the filling status of the PM filled with the instances of the one or more PM events is greater than a (e.g. first) predefined threshold value.

The device 100 further comprises a Selectively discarding PM events unit 108 configured to selectively discard instances of the one or more PM events from the PM buffer depending on the assigned priority, if the filling status of the PM buffer is greater than the (e.g. first) predefined threshold value.

The device 100 further optionally comprises a Selectively discarding PM events mode reporting unit 106 configured to report a selectively discarding mode responsive to monitoring that the filling status of the PM buffer filled with instances of the at least one PM event is greater than the (e.g. first) threshold value. The selectively discarding mode comprises selectively discarding instances of the at least one PM event from the PM buffer depending on the assigned priority.

Any of the units of the device 100 may be implemented by modules configured to provide the corresponding functionality.

The device 100 may also be referred to as, or may be embodied by, a network node. The device 100 and the receiver (e.g. a radio device and/or another network node) are in a radio communication at least for the data transmission at the device 100.

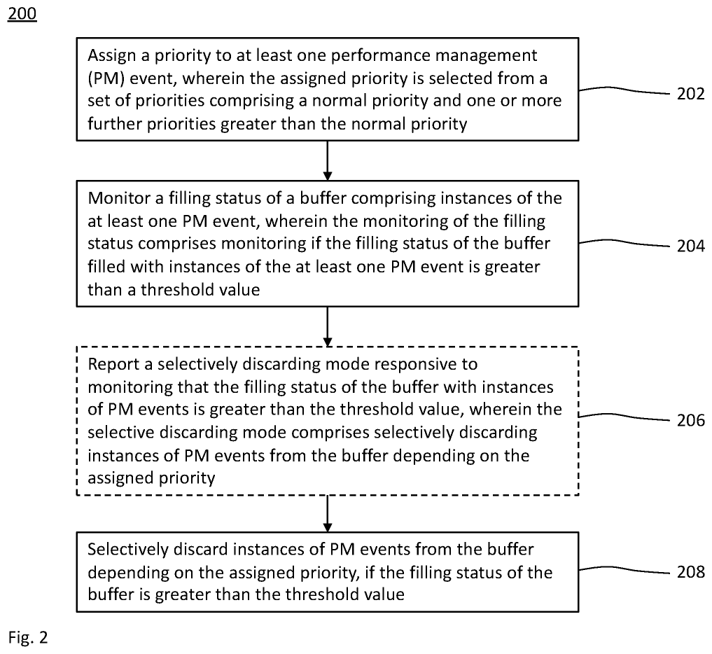

FIG. 2 shows an example flowchart for a method 200 of controlling a PM depending on a load at a network node. The method 200 comprises or initiates a step 202 of assigning a priority to at least one PM event of the PM. The assigned priority is selected from a set of priorities comprising a normal priority (also denoted as “low priority”) and one or more further priorities greater (or “higher”) than the normal priority. The method 200 further comprises or initiates a step 204 of monitoring a filling status of a PM buffer comprising instances of the at least one PM event. The monitoring of the filling status comprises monitoring if the filling status of the PM buffer filled with the instances of the at least one PM event is greater than a (e.g. first) threshold value. The method 200 further comprises or initiates a step 208 of selectively discarding instances of the at least one PM event from the PM buffer depending on the assigned priority, if the filling status of the PM buffer is greater than the (e.g. first) threshold value.

The method 200 further optionally comprises or initiates a step 206 of reporting a selectively discarding mode responsive to monitoring that the filling status of the PM buffer filled with instances of the at least one PM event is greater than the (e.g. first) threshold value. The selectively discarding mode comprises selectively discarding instances of the at least one PM event from the PM buffer depending on the assigned priority.

The method 200 may be performed by the device 100. For example, the modules 102, 104, 106 and 108 may perform the steps 202, 204, 206 and 208, respectively.

The technique may be applied to uplink (UL) or downlink (DL) communications between a network node (e.g. embodying or comprising the device 100) and a radio device and/or to backhaul communications between a network node (e.g. embodying or comprising the device 100) and one or more further network nodes.

The device 100 may be a network node and/or a base station wirelessly connected or connectable to a radio device. Herein, any radio device may be a mobile or portable station and/or any radio device wirelessly connectable to a base station or RAN, or to another radio device. A radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP sidelink connection. Furthermore, any base station may be a station providing radio access, may be part of a radio access network (RAN) and/or may be a node connected to the RAN for controlling radio access. Further a base station may be an access point, for example a Wi-Fi access point.

According to the method 200 of controlling a PM depending on a load at a network node, a generic mechanism for protecting a network node (e.g. an eNB) from signaling pool overflow crash at high load is provided. By the method 200, new functionality is added to the conventional PM framework.

The device 100 comprises one or more instances of an EventAgentLM in which the PM buffers to be monitored by the PM buffer status monitoring unit 104 are comprised. According to the invention, each instance of the EventAgentLM is (e.g. autonomously and/or independently) responsible for the detection of a high load and/or overload state (also denoted as high load and/or overload condition). After detecting a high load and/or overload condition, each instance of the EventAgentLM (e.g. autonomously and/or independently) automatically reduces an observability level of PM events according to preconfigured settings. Each instance of the EventAgentLM is (e.g. autonomously and/or independently) responsible also for informing the configuration part of the network node (e.g. eNB) that the reduced observability mode is active.

By the method 200 of controlling a PM depending on a load at a network node in a wireless communications system, the need for manual intervention is reduced by automating the detection of conditions in which high load and/or overload protection has to be applied. In contrast to the conventional PM framework, PM traffic (and/or the forwarding of PM events) during a network node (e.g. eNB) high load and/or overload state will, according to the present invention, not increase and not lead to signaling pool overflow. By the method 200, PM high load and/or overload protection is implemented, and a robustness of the network node (e.g. eNB) is improved.

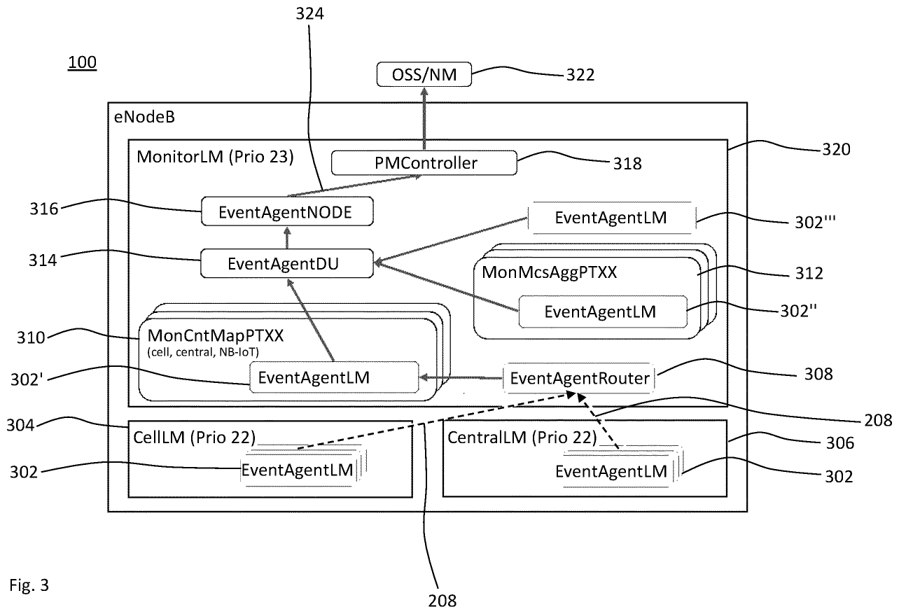

FIG. 3 schematically depicts components of the conventional PM event framework components. PM events are produced in almost all LTE radio access technology (RAT) load modules (LMs) within a network node 100 (e.g. eNB) like CelILM 304, CentralLM 306 and MonitorLM 320. MonitorLM 320 is additionally a singleton responsible for internal collection of PM events within the network node 100 (e.g. eNB) via a plurality of instances of event agents comprising a plurality of copies of EventAgentLM 302 in CelILM 304 and CelILM 306.

Further copies of instances of event agents may be comprised within MonitorLM 320 as EventAgentRouter 308, EventAgentLM 302′ in a thread 310 (e.g., in an LmMonitor Counter Mapping Thread, LmMonCntMapPT, which may be labelled “MonCntMapPTXX”), EventAgentLM 302″ in a thread 312 (e.g., in an LmMonitor MCS Aggregator Thread, LmMonMcsAggPT, which may be labelled “MonMcsAggPTXX”), EventAgentLM 302′″, EventAgentDU 314 and EventAgentNODE 316. Within MonitorLM 320, the PMController 318 forwards the collected (e.g. from multiple instances of EventAgentLM 302′, 302″ and 302′″ through EventAgentDU 314 and EventAgentNODE 316) PM event data to an external operator network data receiver, e.g. OSS and/or NM 322.

A PM event flow is highlighted in dashed and solid arrows at reference signs 208 and 324, respectively. Due to the architecture of the network node 100 (e.g. eNB), sending data between LMs requires using a signaling pool of fixed size. In FIG. 3, the dashed arrows 208 illustrate the interface when the signaling pool is used.

During high load and/or overload, the interface depicted by the dashed arrows 208 is overloaded due to a large of number of PM events being generated by traffic LMs (e.g. CelILM 304 and/or CentralLM 306). Since the components within MonitorLM 320 run on lower priority (e.g., priority 23 in the terminology of G1 hardware) than the PM event producers (not depicted, with e.g. priority 22 in the terminology of G1 hardware) in CelILM 304 and/or in CentralLM 304, under high load and/or overload, the components within MonitorLM 320 do not have enough time to process all data incoming on the interface denoted by the dashed arrows 208. As the signaling pool is exhausted, it cannot be further extended. A network node 100 (e.g. eNB) crash and/or restart occurs.

The present invention affects the instances of EventAgentLM 302 in CelILM 304 and CentralLM 306 and comprises three steps. Firstly, existing PM events are categorized and/or grouped (e.g. into groups) by priority (comprising, e.g., a set including a “normal” and/or “low” priority and one or more “higher” priorities). The categorizing and/or grouping may also be denoted as assigning a priority. Secondly, the use and/or filling status of the PM buffers (also: “signaling buffers” or “event buffers”) on the interfaces at reference sign 208 by each instance of EventAgentLM 302 in CelILM 304 and/or CentralLM 306 is monitored. A (e.g. first) threshold value for the filling status (also: “sensitivity”) is defined by a configurable MOM parameter. Thirdly, the number and/or a selection of PM events to be forwarded (also: “observability of PM events”) over the interfaces 208 is automatically reduced when a high load and/or overload condition is detected. The automatic reduction is based on the assigned priority of the PM events. A target protection and/or load reduction level is defined by the configurable MOM parameter.

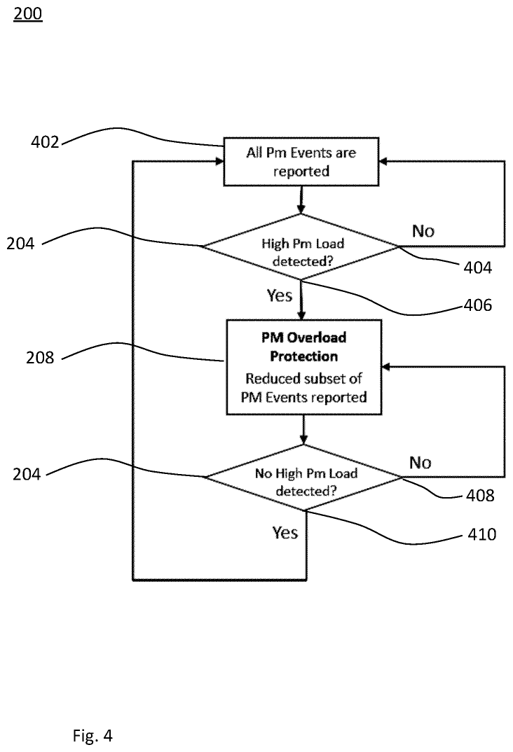

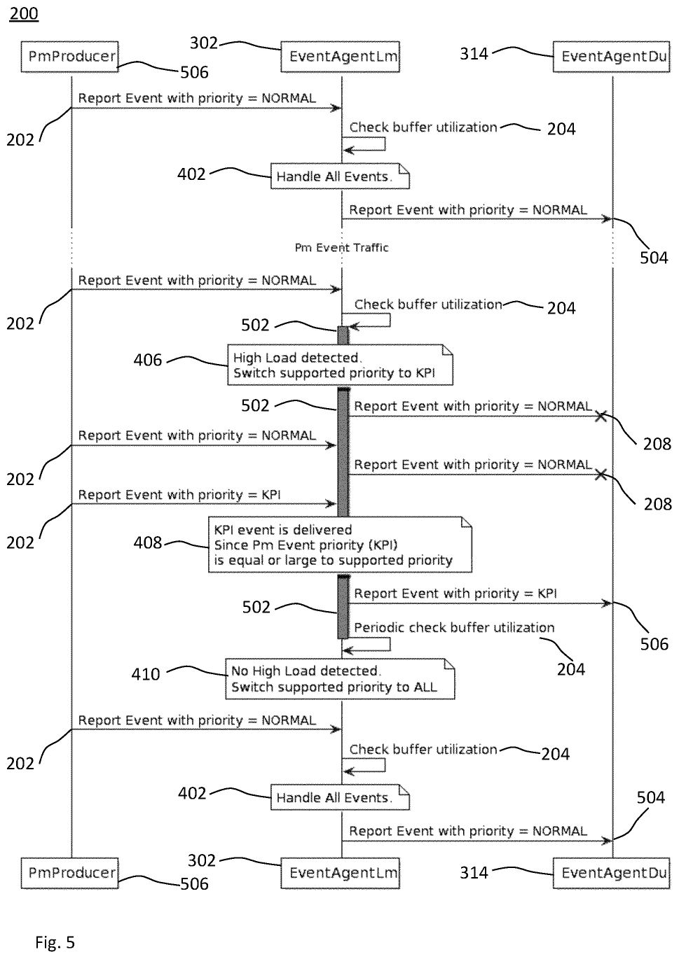

Illustrative examples of the method 200 will now be described with reference to FIGS. 4 and 5. The exemplary method 200 comprises three steps. In a first step, existing PM events (which may be produced by the PMProducer 506 in FIG. 5) are categorized and/or grouped 202 into groups (also: the PM events are assigned priorities). The existing PM events are categorized 202 into five groups with priority (in increasing order): NORMAL (as default), COUNTER_AND_EVENT (for PM events used for counter stepping and also for cell tracing and/or UE tracing), COUNTER (for PM Events used for counter stepping), KPI (for PM events used for KPI counter stepping) and INTERNAL_SUPERVISOR (used for PM events used for internal supervisors within the network node, e.g. eNB, required for internal network node functionalities like load balancing, MIMO Sleep and Cell Sleeping detection).

By default, when no high load and/or overload condition is detected according to the monitoring step 204, PM events from all five groups are reported and/or forwarded at reference sign 402. When an instance of an EventAgentLM 302 (e.g. of CelILM 304) individually and/or autonomously discovers a high load and/or overload condition at reference sign 406, it automatically goes to an PM overload protection state 502 and changes the supported priority level of PM events to be reported and/or forwarded. When no high load and/or overload condition is detected at reference sign 404, the instance of the EventAgentLM 302 continues to report and/or forward 402 all PM events.

By automatically going to the PM overload protection state at reference sign 402, each instance of the EventAgentLM 302 individually and/or autonomously reduces the number of PM events to be sent towards MonitorLM 320, e.g. on the interface at reference sign 208 in FIG. 3. Each instance of the EventAgentLM 302 is also individually and/or autonomously responsible for returning to reporting and/or forwarding all instances of PM events (also denoted as “full observability state”) at reference sign 410 when high load and/or overload conditions are no longer valid. When, during monitoring, a high load and/or overload condition continues to hold, at reference sign 408 the EventAgentLM 302 maintains the PM overload protection state.

In a second step of the exemplary method 200, the above described monitoring of the utilization and/or filling status of the PM buffers for the interface 208 by each instance of the EventAgentLM 302 in CelILM 304 and/or in CentralLM 306 is performed.

Each instance of the EventAgentLM 302 in CelILM 304 and/or in CentralLM 306 comprises 64 buffers of 62 kB (62 kilobytes) size for storing PM events. According to the present invention, each EventAgentLM 302 monitors (e.g. individually and/or autonomously) the utilization and/or the filling status of its buffers. If the utilization and/or filling status becomes higher than a preconfigured threshold (e.g. an activation threshold or first threshold, which may, e.g. initially be set to 50%, that is if the utilization is above an exemplary 32 out of 64 buffers), the EventAgentLM 302 automatically (e.g. individually and/or autonomously) goes to a PM overload protection state by changing a priority level of handled PM events (e.g. by only forwarding and/or reporting instances of PM events with higher priority, e.g. KPI) according to the step 208. By changing the priority level of handled PM events, the EventAgentLM 302 reduces the number of reported PM events.

If the filling status and/or the utilization of the PM buffer falls below a preconfigured threshold (e.g., a deactivation and/or second threshold, which may, e.g., initially be set to 30%, i.e. less than an exemplary 20 out of 64 buffers are used), the EventAgentLM 302 switches back to normal priority of handled events, i.e. all PM events are reported again.

In a third step of the exemplary method 200, the observability and/or the number of forwarded and/or reported PM events is automatically reduced based on the priority of the PM events when a high load and/or overload condition is detected.

When an EventAgentLM 302 detects high PM Load and/or PM overload at reference sign 406, it changes automatically the priority level of supported PM events from “ALL” to a target level (also denoted as PM overload protection state) 502, which is defined by a MOM parameter (e.g., the target level may be any one of COUNTER_AND_EVENT, COUNTER, KPI or INTERNAL_SUPERVISOR). For example, in FIG. 5, at reference sign 506 events with priority KPI are reported during the PM overload protection condition 502. When the EventAgentLM detects that the high PM load and/or PM overload condition has ended, at reference sign 410 it automatically returns to (e.g., “ALL”) PM events supported, i.e. the target priority level may be set to NORMAL, meaning that PM events with priority NORMAL are reported at reference sign 504 in FIG. 5.

Each instance of EventAgentLM 302 monitors 204 its buffer utilization and/or filling status autonomously and decides if a PM overload protection state should be enabled or not. Thresholds for activation and/or deactivation of the PM overload protection state may be global per network node (e.g., eNB) level. Alternatively or in addition, all instances of EventAgentLM 302 may use the same settings. However, each EventAgentLM 302 may go into the PM overload protection state at a different time.

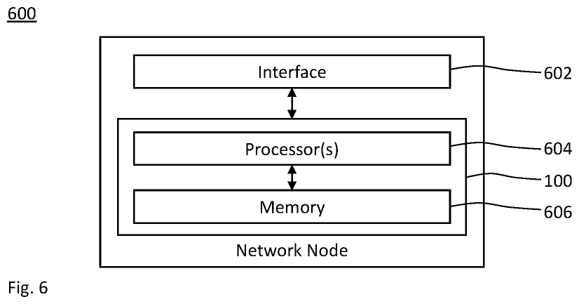

FIG. 6 shows a schematic block diagram for an embodiment of the device 100. The device 100 comprises one or more processors 604 for performing the method 200 and memory 606 coupled to the processors 604. For example, the memory 606 may be encoded with instructions that implement at least one of the modules 102, 104, 106 and 108.

The one or more processors 604 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 606, network node functionality. For example, the one or more processors 604 may execute instructions stored in the memory 606. Such functionality may include providing various features and steps discussed herein, including any of the benefits disclosed herein. The expression “the device being operative to perform an action” may denote the device 100 being configured to perform the action.

As schematically illustrated in FIG. 6, the device 100 may be embodied by a network node 600, e.g., functioning as a base station serving the radio device. The network node 600 comprises a radio interface 602 coupled to the device 100 for radio communication with one or more radio devices (e.g., UEs).

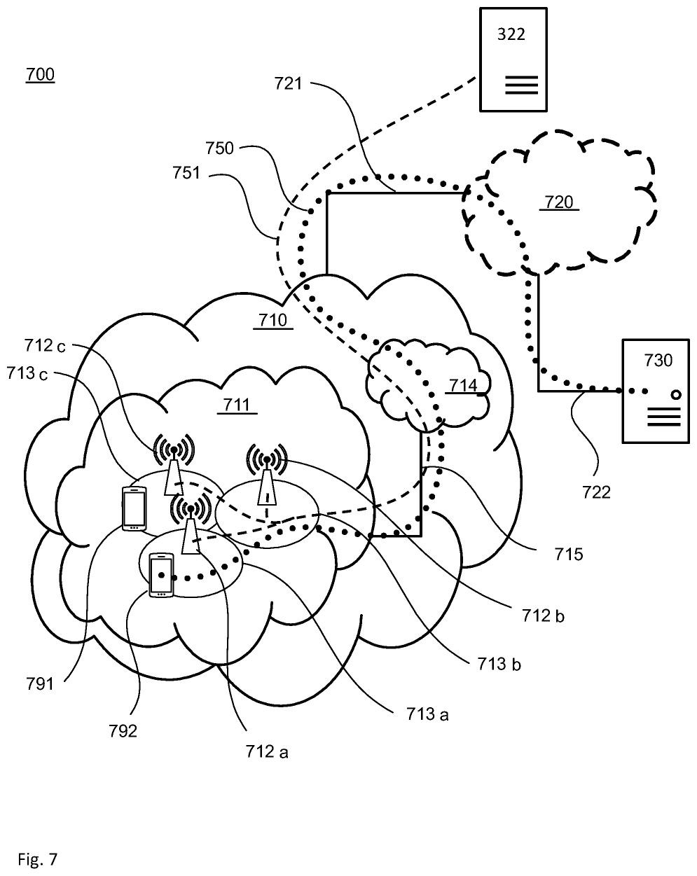

With reference to FIG. 7, in accordance with an embodiment, a communication system 700 includes a telecommunication network 710, such as a 3GPP-type cellular network, which comprises an access network 711, such as a radio access network, and a core network 714. The access network 711 comprises a plurality of base stations 712a, 712b, 7012c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first user equipment (UE) 791 located in coverage area 713c is configured to wirelessly connect to, or be paged by, the corresponding base station 712c. A second UE 792 in coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. The connections 721, 722 between the telecommunication network 710 and the host computer 730 may extend directly from the core network 714 to the host computer 730 or may go via an optional intermediate network 720. The intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system 700 of FIG. 7 as a whole enables connectivity between one of the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, a base station 712 may not or need not be informed about the past routing of an incoming downlink communication with data originating from a host computer 730 to be forwarded (e.g., handed over) to a connected UE 791. Similarly, the base station 712 need not be aware of the future routing of an outgoing uplink communication originating from the UE 791 towards the host computer 730.

By virtue of the method 200 being performed by any one of the base stations 712, the performance of the OTT connection 750 can be improved, e.g., in terms of increased throughput and/or reduced latency.

The host computer 730 may be used as termination and/or source for a data transfer to and/or from at least one of the UEs 791 and 792, e.g., along the dotted path illustrates in FIG. 7 for user data from UE towards host computer.

Furthermore, the communication system 700 may comprise a further path 751 for data of PM events (also: PM events data). The data of the PM events may be generated at radio base stations 712 (i.e., embodiments of the network node 100). The data of the PM events is transmitted to OSS 322 or any other network managing node, e.g. in an operator network.

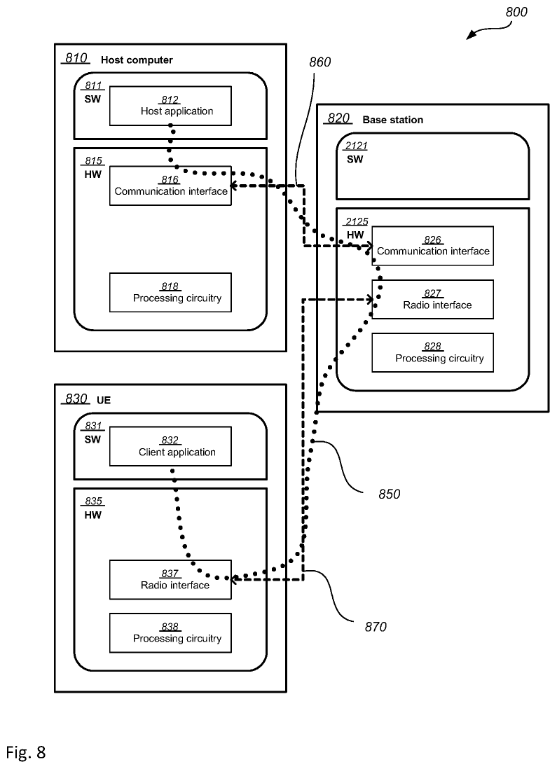

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as a UE 830 connecting via an OTT connection 850 terminating at the UE 830 and the host computer 810. In providing the service to the remote user, the host application 812 may provide user data, which is transmitted using the OTT connection 850. The user data may depend on the location of the UE 830. The user data may comprise auxiliary information or precision advertisements (also: ads) delivered to the UE 830. The location may be reported by the UE 830 to the host computer, e.g., using the OTT connection 850, and/or by the base station 820, e.g., using a connection 860.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with a UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, base station 820 and UE 830 illustrated in FIG. 8 may be identical to the host computer 730, one of the base stations 712a, 712b, 712c and one of the UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the use equipment 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration(s) or reconfiguration of the network).

The wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may reduce the latency and improve the data rate and thereby provide benefits such as better responsiveness.

A measurement procedure may be provided for the purpose of monitoring data rate, latency and other factors on which the one or more embodiments improve. There may further be an optional network functionality for reconfiguring the OTT connection 850 between the host computer 810 and UE 830, in response to variations in the measurement results. The measurement procedure and/or the network functionality for reconfiguring the OTT connection 850 may be implemented in the software 811 of the host computer 810 or in the software 831 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer's 810 measurements of throughput, propagation times, latency and the like. The measurements may be implemented in that the software 811, 831 causes messages to be transmitted, in particular empty or “dummy” messages, using the OTT connection 850 while it monitors propagation times, errors etc.

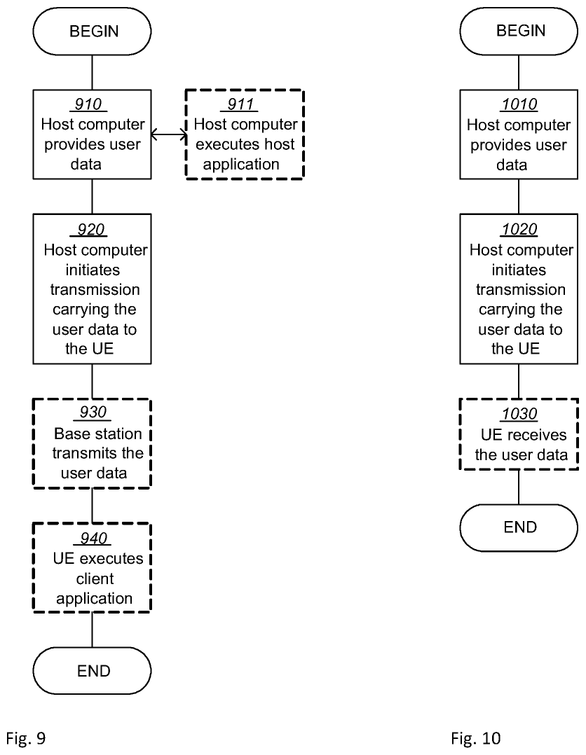

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In a first step 910 of the method, the host computer provides user data. In an optional substep 911 of the first step 910, the host computer provides the user data by executing a host application. In a second step 920, the host computer initiates a transmission carrying the user data to the UE. In an optional third step 930, the base station transmits to the UE the user data which was carried in the transmission that the host computer initiated, in accordance with the teachings of the embodiments described throughout this disclosure. In an optional fourth step 940, the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In a first step 1010 of the method, the host computer provides user data. In an optional substep (not shown) the host computer provides the user data by executing a host application. In a second step 1020, the host computer initiates a transmission carrying the user data to the UE. The transmission may pass via the base station, in accordance with the teachings of the embodiments described throughout this disclosure. In an optional third step 1030, the UE receives the user data carried in the transmission.

As has become apparent from above description, embodiments of the technique improves network node robustness under high load and/or overload conditions by reducing the risk of crash and/or restart caused by an overload of PM events. Automatic detection of high load and/or overload conditions and reducing observability of PM events in a controlled way allows a wireless communication system operator to keep the counter(s) and KPI related data from/at high load and/or overload period without increased risk of network node crash.

Embodiments of the technique can solve the conventional problem of a need for manual intervention, which, according to the subject technique is reduced or avoided by the assigning and monitoring steps for the detection of conditions in which PM overload protection has to be applied. PM traffic (also denoted as PM events) during high load and/or overload at the network node will not increase and not lead to signaling pool overflow. The PM overload protection mechanism as disclosed herein improves the robustness of the network node.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of controlling a performance management, PM, depending on a load at a network node in a wireless communications system, the method comprising or initiating the steps of:
assigning a priority to at least one PM event of the PM, wherein the assigned priority is selected from a set of priorities comprising a normal priority and one or more further priorities greater than the normal priority;
monitoring a filling status of a PM buffer comprising instances of the at least one PM event, wherein the monitoring of the filling status comprises monitoring if the filling status of the PM buffer filled with the instances of the at least one PM event is greater than a threshold value; and
selectively discarding instances of the at least one PM event from the PM buffer depending on the assigned priority, if the filling status of the PM buffer is greater than the threshold value.

2. The method of claim 1, wherein the selectivity of the selective discarding comprises discarding instances of the at least one PM event with a priority less than a predefined priority.

3. The method of claim 1, wherein the selectively discarding comprises:
discarding instances of the at least one PM event from the PM buffer, to which the normal priority is assigned, optionally if the at least one further priority comprises exactly one further priority that is greater than the normal priority.

4. The method of claim 1, wherein the selectively discarding comprises:
discarding instances of the at least one PM event from the PM buffer, to which a priority less than a preselected one of the further priorities greater than the normal priority is assigned, optionally if the one or more further priorities comprises at least two further priorities that are greater than the normal priority.

5. The method of claim 1, further comprising the step of:
reporting a selectively discarding mode responsive to monitoring that the filling status of the PM buffer filled with instances of the at least one PM event is greater than the threshold value, wherein the selectively discarding mode comprises selectively discarding instances of the at least one PM event from the PM buffer depending on the assigned priority.

6. The method of claim 1, wherein the step of monitoring the filling status of the PM buffer further comprises monitoring if the filling status of the PM buffer is less than a second threshold value, wherein the second threshold value is less than the threshold value.

7. The method of claim 6, wherein the step of selectively discarding instances of PM events comprises not discarding any instance of the at least one PM event from the PM buffer, if the filling status of the PM buffer is less than the second threshold value.

8. The method of claim 1, wherein the step of monitoring the filling status of the PM buffer further comprises monitoring if the filling status of the PM buffer is greater than a third threshold value, wherein the third threshold value is greater than the threshold value.

9. The method of claim 8, wherein the step of selectively discarding further comprises:
if the filling status of the PM buffer is greater than the third threshold value,
starting to discard instances of the at least one PM event for a group of radio devices, among the radio devices served by the network node, irrespective of the assigned priority or for all priorities except at least one essential priority; or
starting to reject radio devices at the network node.

10. The method of claim 8, wherein the step of monitoring a filling status of a PM buffer further comprises monitoring if the filling status of the PM buffer is less than a fourth threshold value, wherein the fourth threshold value is greater than the threshold value and the fourth threshold value is less than the third threshold value.

11. The method of claim 10, wherein the step of selectively discarding further comprises:
if the filling status of the PM buffer is less than the fourth threshold value,
stopping to discard instances of the at least one PM event irrespective of the assigned priority or for all priorities except at least one essential priority; or
stopping to reject radio devices at the network node.

12. The method of claim 1, wherein at least one of:
the threshold value;
the second threshold value;
the third threshold value; and
the fourth threshold value
is a configurable parameter for the filling status of the PM buffer.

13. The method of claim 12, wherein the at least one configurable parameter for the filling status of the PM buffer is at least one of specific and unique to the network node.

14. The method of claim 1, wherein the at least one further priority comprises four priorities and/or wherein the set of priorities comprises five priorities.

15. The method of claim 1, wherein the method is performed by a radio access control, RAC, layer of the network node, optionally wherein the method is performed by each instance of a plurality of instances of an event agent, EventAgentLM, of a cell load module, CellLM, and/or of a central load module, CentralLM, within the RAC layer.

16-18. (canceled)

19. A device for controlling a performance management, PM, depending on a load at a network node in a wireless communications system, the device comprising at least one processor and a memory, said memory comprising instructions executable by said at least one processor, whereby the device is operative to:
assign a priority to at least one PM event of the PM, wherein the assigned priority is selected from a set of priorities comprising a normal priority and one or more further priorities greater than the normal priority;
monitor a filling status of a PM buffer comprising instances of the at least one PM event, wherein the monitoring of the filling status comprises monitoring if the filling status of the PM buffer filled with instances of PM events is greater than a threshold value; and
selectively discard instances of the at least one PM event from the PM buffer depending on the assigned priority, if the filling status of the PM buffer is greater than the threshold value.

20. (canceled)

21. A base station configured to communicate with a user equipment, UE, the base station comprising a radio interface and processing circuitry configured to:
assign a priority to at least one performance management, PM, event of a PM, wherein the assigned priority is selected from a set of priorities comprising a normal priority and one or more further priorities greater than the normal priority;
monitor a filling status of a PM buffer comprising instances of the at least one PM event, wherein the monitoring of the filling status comprises monitoring if the filling status of the PM buffer filled with the instances of the at least one PM event is greater than a threshold value; and
selectively discard instances of the at least one PM event from the PM buffer depending on the assigned priority, if the filling status of the PM buffer is greater than the threshold value.

22-24. (canceled)
